(19) United States
(12) Patent Application Publication
(10) Pub. No.: US 2011/0115457 A1
(43) Pub. Date: May 19, 2011

(54) METHOD OF CONTROLLING OF A SWITCHED-MODE POWER SUPPLY AND CORRESPONDING POWER SUPPLY

(75) Inventors: Mehdi Gati, Sceaux (FR); Ahmed Ketfi-Cherif, Elancourt (FR); Michel Mensler, Montigny-Le-Bretonneux (FR); Philippe Pognant-Gros, Tassin la demi-Lune (FR)

(73) Assignee: Renault S.A.S., Boulogne-Billancourt (FR)

(21) Appl. No.: 12/738,806

(22) PCT Filed: Oct. 13, 2008
(86) PCT No.: PCT/FR2008/051853

§ 371 Date: Dec. 6, 2010

(30) Foreign Application Priority Data
Oct. 22, 2007 (FR) 0758461

(51) Int. Cl. G05F 1/618

(52) U.S. Cl. 323/284

(57) ABSTRACT

A method of controlling a switched-mode power supply and corresponding power supply including a switching cell including two series-connected configurable on/off switches; in which the switching cell is configured cyclically: for a duration T1, in an on state, in which a first on/off switch is closed and the second on/off switch is open; and, for a duration T2, in an off state, in which the second on/off switch is closed and the first on/off switch is open. The switching cell is also configured in a transition state, in which the first on/off switch and the second on/off switch are open: for a duration Tm1 between the off state and the on state; and for a duration Tm2 between the on state and the off state; and the durations T1 and/or T2 of the on and off states are determined according to the durations Tm1 and/or Tm2, respectively, of the transition states.

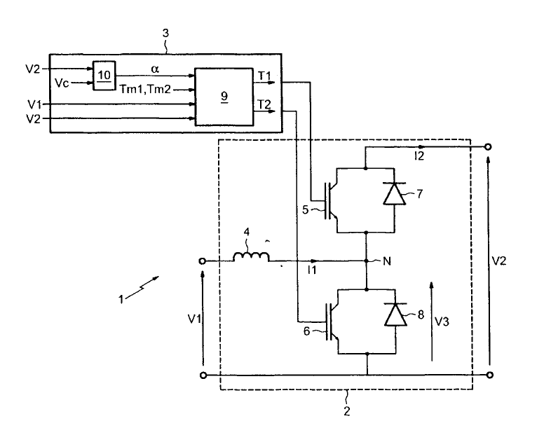

The present invention relates to switched-mode power supplies, and more particularly those with switching.

Switched-mode power supplies are electrical elements that make it possible to obtain, from a DC voltage or from a DC current, a DC voltage or a DC current of a different value. Thus, in the case of hybrid or electric motor vehicles, the various electrical equipment items or the electric engine can be powered by an energy storage element (for example a battery) and offer an energy efficiency that is directly proportional to the power supply voltage. However, the voltage delivered by the storage element can vary as a function of the state of charge thereof.

In order to keep a power supply voltage that is always high regardless of the state of charge of the storage element, a switched-mode power supply is generally placed between the storage element and the electrical equipment items or the electric engine. The purpose of the switched-mode power supply is to modify and control the power supply voltage for the equipment items or for the engine, in order to keep their energy efficiency at a high value. However, the use of a switched-mode power supply creates additional losses in the electric circuit.

More specifically, let us consider the case of switched-mode power supplies with switching comprising two series-mounted switches. The switches are generally bipolar or field-effect transistors. They are controlled by open and close signals sent periodically and with an offset between the two switches so that the two switches are not in the same switching state at the same time (closed or open).

By periodically alternating the two configurations and by varying the duration of a configuration during a period, it is possible to obtain a desired voltage and/or current value at the output of the switched-mode power supply. However, the response time of the switches to the control signal is not zero, and this leads to a risk of having both switches in the same switching state at the same time. Thus, if the two switches are closed at the same time, there is a risk of short-circuiting the storage element or the electrical equipment.

To avoid the configuration in which the two switches of the switched-mode power supply are closed at the same time, there is provided, on each change of configuration of the switched-mode power supply, a duration during which the two switches are open. However, these durations, called dead times, cause a non-linear response from the switched-mode power supply, and this non-linearity increases with the ratio of the dead time duration to the duration of a period.

One solution for limiting the non-linearity of the system is to adapt the duration of the dead times notably by minimizing it. The patent application US 2004/0130307 thus discloses a switched-mode power supply with switching wherein the closure of one transistor is controlled by the opening of the other. The patent application WO 2004/114509 relates to a switched-mode power supply in which the duration of the dead times is determined as a function of the voltage at the terminals of one of the transistors. Finally, the patent application US 2006/0152204 uses a control system making it possible, from the difference between the output voltage and the reference voltage, to determine the dead time duration to be applied and control the conversion. However, the reduction in the dead times remains limited by the technology of the switches used.

Another solution consists in reducing the switch control frequency. However, this solution leads to an increase in the losses in the switched-mode power supply and therefore reduced efficiency.

The aim of the invention is to control a switched-mode power supply in such a way as to limit the losses therein.

The aim of the invention is also to control a switched-mode power supply at a high switching frequency while limiting the effect of the dead times on its response.

According to one aspect of the invention, there is proposed a method of controlling a switched-mode power supply comprising a switching cell having two series-mounted configurable switches, and wherein the switching cell is configured cyclically:

in a conducting state, for a duration T1, in which a first switch is closed and the second switch is open, and

in a blocking state, for a duration T2, in which the second switch is closed and the first switch is open.

According to the method, the switching cell is also configured in a transitional state, in which the first switch and the second switch are open:

for a duration Tm1 between the blocking state and the conducting state, and

for a duration Tm2 between the conducting state and the blocking state, and the durations T1 and/or T2 are determined as a function of the durations Tm1 and/or Tm2.

Thus, the method makes it possible to take into account the duration of the dead times in controlling the switched-mode power supply in such a way as to correct the effect of the dead times on the response of the switched-mode power supply. More particularly, the purpose of the method is not to reduce the duration of the dead times as much as possible, but to compensate for its effects by consequently controlling the respective duration of the blocking state and of the conducting state of the switched-mode power supply. Thanks to compensation of the dead times, it once again becomes possible to increase the switching frequency of the switched-mode power supply, and therefore its performance levels, despite the technological limitations associated with the switches.

Preferentially, the durations T1 and/or T2 of the conducting and blocking states respectively are determined, in a non-linear fashion, as a function of a desired duty cycle.

Unlike feedback loops, which modify only linearly the operation of a switched-mode power supply as a function of the difference between the output and the setpoint, the method also makes it possible to compensate the non-linear effects introduced by the dead times.

Preferentially, the durations T1 and/or T2 of the conducting and blocking states respectively are determined, as a function of the desired duty cycle, from a non-linear model dependent on the input V1 and output V2 voltages of the switched-mode power supply, and on the durations Tm1 and/or Tm2 of the transitional states.

The parameters of the non-linear model that make it possible to calculate the durations T1 and/or T2 of the conducting and blocking states are determined as a function of different quantities of the system, notably the input and output voltages of the switched-mode power supply and the durations of the transitional states.

Preferentially, the desired duty cycle is determined in a linear fashion as a function of the difference between the output voltage V2 of the switched-mode power supply and a setpoint voltage Vc.

The method can include a linear servo-control step that makes it possible to adapt the desired duty cycle of the switched-mode power supply as a function of the output signal and of the control signal. In particular, this servo-control does not, on its own, make it possible to compensate for the effects of the dead times, but it does make it possible to take into account, in a first stage, any difference between the output voltage and the setpoint voltage.

According to another aspect of the invention, there is proposed a switched-mode power supply comprising:

a switching cell having two switches that are series-mounted and can be configured in response to a control signal, and

control means able to deliver the control signal in such a way as to cyclically configure the switching cell:
in a conducting state, in which a first switch is closed and the second switch is open, and
in a blocking state, in which the second switch is closed and the first switch is open.

According to the invention, the control means are able to deliver the control signal in such a way as to also configure the switching cell in a transitional state, in which the first switch and the second switch are open:
for a duration Tm1 between the blocking state and the conducting state, and
for a duration Tm2 between the conducting state and the blocking state, and the durations T1 and/or T2 are determined by the control means as a function of the durations Tm1 and/or Tm2.

Preferentially, the control means comprise a non-linear means receiving a desired duty cycle and delivering the durations T1 and/or T2.

Preferentially, the non-linear means comprises a non-linear model dependent on the input V1 and output V2 voltages of the switched-mode power supply, and on the durations Tm1 and/or Tm2.

Preferentially, the control means comprise a linear means receiving the difference between the output voltage V2 of the switched-mode power supply and a setpoint voltage Vc, and delivering the desired duty cycle.

Preferentially, a diode is mounted in parallel with each switch.

According to another aspect, there is proposed a motor vehicle comprising a switched-mode power supply according to the invention.

Other aims, features and benefits of the invention will become apparent from reading the following detailed description of an embodiment, taken by way of non-limiting example and illustrated by the appended drawing.

The appended FIGURE represents a switched-mode power supply 1 comprising a switching cell 2 and control means 3.

The switching cell 2 has two input terminals via which it receives an input voltage V1 originating, for example, from a storage means such as a battery. It also has two output terminals via which it delivers an output voltage V2 for example to electrical equipment or to an electric engine of a motor vehicle.

In the example illustrated in the appended figure, the first input terminal is linked to the first output terminal, while the second input terminal is linked to a first terminal of an inductive element 4, for example a coil. The inductive element 4 makes it possible in particular to limit the current during the switching of the switches.

The switching cell 2 also comprises a first switch 5 and a second switch 6. The switches 5 and 6 are, for example, IGBT (insulated gate bipolar transistor) or field-effect transistors. It is assumed hereinafter in the description that the two switches 5 and 6 are IGBT transistors.

The two switches 5, 6 and the inductive element 4 are linked together, at an electrical node N. More specifically, the electrical node N links the second terminal of the inductive element 4, the emitter of the first switch 5 and the collector of the second switch 6. The collector of the first switch 5 is linked to the second output terminal of the switching cell 2, while the emitter of the second transistor 6 is linked to the first input terminal and to the first output terminal of the switching cell 2. The bases of the two switches 5 and 6 are linked to the control means 3 which can then configure the switching cell 2 in different states.

In parallel with the first switch 5 and the second switch 6 there are mounted respectively a first diode 7 and a second diode 8, the cathodes of the first diode 7 and of the second diode 8 being linked respectively to the collector of the first switch 5 and of the second switch 6.

Hereinafter in the description, the expression intermediate voltage V3 will be used to denote the voltage between the electrical node N and the first input terminal or the first output terminal of the switching cell. The voltage V3 therefore represents the voltage that exists between the collector and the emitter of the second switch 6 or else the voltage that exists between the cathode and the anode of the second diode 8.

In theory, the control means 3 send complementary control signals so as to successively configure the switching cell 2 in two states: a first so-called conducting state in which the first switch 5 is closed and the second switch 6 is open, and a second so-called blocking state in which the first switch 5 is open and the second switch 6 is closed.

In the conducting state, the current I1 circulating in the inductive element 4 is equal to the current I2 circulating in the second output terminal, and the intermediate voltage V3 is equal to the output voltage V2. In the blocking state, the current I2 circulating in the second output terminal is zero and the intermediate voltage V3 is also zero.

The control means 3 make it possible to successively and periodically alternate the two configuration states of the switching cell 2. Thus, when the period of the control signals is equal to T and the control signals configure the switching cell 2 in the conducting state for a duration αT (in which a is the duty cycle and is between 0 and 1) and in the blocking state for a duration T-αT, then a conversion of the voltage and of the current is obtained according to the relations (1) and (2):

$$\begin{matrix}〈 V 2 〉 = \frac{1}{α} 〈 V 3 〉 & ( 1 ) \\ 〈 I 2 〉 = α 〈 I 1 〉 & ( 2 )\end{matrix}$$

in which the notation <x> designates the average time value of the quantity x.

In practice, the response time of the switches 5, 6 is not zero and there is a risk, on each change of configuration of the switching cell 2, that the two switches will be in the same state (closed or open) which can create problems, notably a short circuiting of the output voltage V2 when the two switches 5, 6 are closed.

The control means 3 therefore introduce a transitional state during the switchover from the conducting state to the blocking state and during the switchover from the blocking state to the conducting state. In this transitional state, the two switches 5, 6 are open for a duration called dead time. Hereinafter in the description, Tm1 will be used to designate the duration of the transitional state upon the switchover from the blocking state to the conducting state, and Tm2 the duration of the transitional state upon the switchover from the conducting state to the blocking state.

It will be assumed hereinafter in the description, for the purposes of simplification, that: Tm1=Tm2=Tm.

During the transitional states, the so-called “free wheeling” diodes 7, 8 allow the current I1 to circulate, depending on its sign, to the first or second output terminal of the switching cell 2. However, when the current I1 is cancelled for the duration of a transitional state, it remains so until the end of the transitional state, which modifies the response of the switching cell 2 by making it in particular non-linear.

In order to keep the response of the switching cell 2 as linear as possible, the control means 3 adapt the control signals of the switches 5, 6 in order to compensate the effect of the transitional states on the response of the switching cell 2. Thus, in addition to reducing the durations of the transitional states, their effects are also compensated, in particular by modification of the desired duty cycle a, so as to be able to keep the switching frequency (1/T) of the switching cell 2 high.

The non-linear effects of the transitional states on the response of the switching cell 2 can be expressed in the form (3):

<V3>=F(α,V2>,<V1>, Tm) (3)

To compensate these effects, the desired duty cycle α can be modified to a corrected duty cycle α′ so as to restore a linear relationship between the voltage <V3> and the voltage <V2>, in the following form (1′):

$$〈 V 2 〉 = \frac{1}{{α}^{′}} 〈 V 3 〉 \qquad ( {1}^{′} )$$

By controlling the switching cell 2 with the duly determined corrected duty cycle α′, it is then possible to compensate, at least partly, the non-linearity of the response of the switching cell 2 and therefore keep a high switching frequency.

In particular, the control means 3 can use the following system of non-linear equations (4) to calculate α′, and then deduce therefrom the durations T1=α′T-Tm1 and T2=T-α′T-Tm2:

$$\{ \begin{matrix}{α}^{′} = ( α - {α}_{m} ) & if α \leq {α}_{1} + {α}_{m} \\ {α}^{′} = \frac{( {α}_{1} - {α}_{2} ) \cdot α + {α}_{2} \cdot {α}_{m}}{{α}_{1} - {α}_{2} + {α}_{m}} & if {α}_{1} + {α}_{m} \leq α \leq {α}_{2} \\ {α}^{′} = α & if {α}_{2} \leq α \leq {α}_{3} \\ {α}^{′} = \frac{( {α}_{3} - {α}_{4} ) \cdot α - {α}_{3} \cdot {α}_{m}}{{α}_{3} - {α}_{4} + {α}_{m}} & if {α}_{3} \leq α \leq {α}_{4} - {α}_{m} \\ {α}^{′} = ( α + {α}_{m} ) & if α \geq {α}_{4} - {α}_{m}\end{matrix} \qquad ( 4 )$$

in which αₘ=Tm/T, and the parameters α₁, α₂, α₃, α₄ are determined as a function of V1 and V2. In particular, the parameters αₗ, α₂, α₃, α₄ can be determined from stored values, or else by theoretical calculation or indeed by experimental identification.

It is observed, from the system of equations (4), that the corrected duty cycle α′ does not vary proportionally as a function of the desired duty cycle α. In particular, the variation of the corrected duty cycle α′ as a function of the desired duty cycle α is not constant but depends on the value of the duty cycle α. A non-linear correction of the desired duty cycle α is therefore clearly observed.

The non-linear means 9 can then calculate the durations T1 and T2 and control the switches 5, 6 accordingly. There is thus obtained a less non-linear behavior of the switching cell 2 thanks to the fact that the dead times are taken into account. Furthermore, it is possible to work at a high switching frequency with a limited deterioration of the output signal.

The control means 3 can also comprise a linear looping system that makes it possible to correct drifts or deviations that can occur in the switching cell 2. Thus, the control means 3 can include a linear means 10 that makes it possible to determine the desired duty cycle as a function of the difference between, for example, the output voltage V2 and a setpoint voltage Vc. This is a servo-controlling of the switched-mode power supply 1 that makes it possible to obtain as output a voltage V2 close to the setpoint voltage Vc. The linear means 10 thus receives the output voltage V2 and the setpoint voltage Vc, then linearly determines, as a function of the difference between these two voltages, the desired duty cycle a. The desired duty cycle a is determined so as to obtain an output voltage V2 equal to the setpoint voltage Vc, but it does not take into account the dead time durations: it is therefore delivered to the nonlinear means 9 to obtain the corrected duty cycle α′.

The switched-mode power supply 1 therefore makes it possible to limit the effects of dead times on the response of the switching cell, by modeling in particular the non-linear components of the response and by modifying the control of the switches so as to compensate these non-linear components.

The invention is not limited solely to the embodiment described previously. In particular, the invention also applies to a switching cell comprising several circuits mounted in parallel between the input terminals and the output terminals, and each comprising two switches, two diodes and an inductive element as described previously.

Similarly, the inventive switched-mode power supply can also be used to power DC/AC converters mounted downstream, which in turn power electrical equipment. It can also include a filtering capacitance linked between the output terminals of the switching cell.

Finally, the invention is preferentially used as voltage step-up-type switched-mode power supply, and applied in particular to the field of motor vehicles. Thus, by placing a switched-mode power supply according to the invention between the storage means and the electrical equipment, it becomes possible to increase their energy efficiency by in particular increasing the output voltage. However, the invention can also be applied to voltage step-down-type switched-mode power supplies, or even to current step-up or step-down-type switched-mode power supplies.

1-10. (canceled)

11. A method of controlling a switched-mode power supply including a switching cell including two series-mounted configurable switches, wherein the switching cell is configured cyclically:
in a conducting state, for a duration T1, in which a first switch is closed and a second switch is open, and
in a blocking state, for a duration T2, in which the second switch is closed and the first switch is open,
wherein the switching cell is also configured in a transitional state, in which the first switch and the second switch are open:
for a duration Tm1 between the blocking state and the conducting state, and
for a duration Tm2 between the conducting state and the blocking state,
and wherein the durations T1 and/or T2 are determined as a function of the durations Tm1 and/or Tm2.

12. The control method as claimed in claim 11, wherein the durations T1 and/or T2 are determined, in a non-linear fashion, as a function of a desired duty cycle.

13. The method as claimed in claim 12, wherein the durations T1 and/or T2 are determined, as a function of the desired duty cycle, from a non-linear model dependent on input and output voltages of the switched-mode power supply, and on the durations Tm1 and/or Tm2.

14. The control method as claimed in claim 12, wherein the desired duty cycle is determined in a linear fashion as a function of the difference between an output voltage of the switched-mode power supply and a setpoint voltage.

15. A switched-mode power supply comprising:
a switching cell including two switches that are series-mounted and can be configured in response to a control signal; and
a controller configured to deliver the control signal in such a way as to cyclically configure the switching cell:
in a conducting state, for a duration T1, in which a first switch is closed and a second switch is open, and
in a blocking state, for a duration T2, in which the second switch is closed and the first switch is open,
wherein the controller is further configured to deliver the control signal in such a way as to also configure the switching cell in a transitional state, in which the first switch and the second switch are open:
for a duration Tm 1 between the blocking state and the conducting state, and
for a duration Tm2 between the conducting state and the blocking state,
and wherein the durations T1 and/or T2 are determined by the controller as a function of the durations Tm1 and/or Tm2.

16. The switched-mode power supply as claimed in claim 15, wherein the controller comprises a non-linear means receiving a desired duty cycle and delivering the durations T1 and/or T2.

17. The switched-mode power supply as claimed in claim 16, wherein the non-linear means comprises a non-linear model dependent on the input and output voltages of the switched-mode power supply, and on the durations Tm1 and/or Tm2.

18. The switched-mode power supply as claimed in claim 16, wherein the controller comprises a linear means receiving the difference between an output voltage of the switched-mode power supply and a setpoint voltage, and delivering the desired duty cycle.

19. The switched-mode power supply as claimed in claim 15, wherein a diode is mounted in parallel with each switch.

20. A motor vehicle comprising a switched-mode power supply as claimed in claim 15.
